(19) United States
(12) Patent Application Publication
(10) Pub. No.: US 2021/0007383 A1
(43) Pub. Date: Jan. 14, 2021

(54) MEAL IN A PILL AND METHODS FOR THE SAME

(71) Applicant: Meepo Inc., Yardley, PA (US)

(72) Inventors: Matthew Elonis, Yardley, PA (US); Andres Alberto Arrocha-Arcos, Philadelphia, PA (US); Rogelio Cervantes-Alcala, Cuernavaca (MX)

(73) Assignee: Meepo Inc., Yardley, PA (US)

(21) Appl. No.: 16/919,357

(22) Filed: Jul. 2, 2020

Related U.S. Application Data
(60) Provisional application No. 62/871,972, filed on Jul. 9, 2019.

(51) Int. Cl. A23L 33/175; A23L 33/18; A23L 33/125; A23L 27/00; A23L 33/115; A23L 33/22; A23L 33/155; A23L 33/16; A23L 29/281; A23P 30/10; A23L 29/269; A23L 5/43; A23L 27/12

(52) U.S. Cl. CPC A23L 33/175; A23L 33/18; A23L 33/125; A23L 27/86; A23L 33/115; A23L 33/22; A23V 2002/00; A23L 33/16; A23L 29/284; A23P 30/10; A23L 29/272; A23L 5/43; A23L 27/13; A23L 33/155

(57) ABSTRACT

A complete meal mimic is provided. It may be in the form of a small mass, and may contain free amino acids or peptides to mimic proteins in a meal. Digestion of the mimic may be at a controlled rate, emulating that of real food. The mimic may include the equivalent of 10-30 g protein in the form of amino acids and peptides, 10 to 20 grams of carbohydrates in the form of starches and fiber and 10 to 30 g of lipids from different oils. The oils may be one or more from avocado, coconut, and flaxseed. The mimic also may contain micro-nutrients provided by meals, including minerals and vitamins in bio-available forms. The mimic may stand in the place of a meal in the 100 calories to 500 calories range. The flavor of the mimic may include natural bitter blockers and/or mushroom powder.

### CROSS REFERENCE TO RELATED APPLICATION

This application claims the benefit of U.S. 62/871,972, filed Jul. 9, 2019, which is incorporated by reference as if fully set forth.

### FIELD

A meal mimic comprising peptides or amino acids, a high density, and high calories. The meal mimic is in a solid mass.

### BACKGROUND

Nutritional supplements are popular. Others have used raw components such as full proteins from milk, soybean, whey, and other sources. In many cases these formulas are liquid formulas are not palatable, and do not mimic real meals. If they use amino acids they are limited by the current bitter blocking technology and also they provide a very limited amount of calories. Others have produced protein bars, but these also lack the aspects of a real meal. See US20070286909, U.S. Pat. No. 3,697,287A, U.S. Pat. No. 5,132,113A, WO/2013/102873, WO2013102873A2, RU2383207C2, GB2039709A, and EP2384124B1, which are incorporated herein by references as if fully set forth. See also rice bars, CLIF BUILDER′S—Protein Bar, and ProBar. The ratio of calories to the weight of this kind of products is around 4 Cal/g and below. The ratio of calories to the weight of this kind of products is around 4 Cal/g and below. Other classical products are ENSURE and GLUCERNA from Abbot company.

Recently, a physio-mimic effect is reported by Giarratana, N. et al. “A New Phe-Free Protein Substitute Engineered to Allow a Physiological Absorption of Free Amino Acids for Phenylketonuria” (2018) J. Inborn Errors of Metabolism 6: 1-9, which is incorporated herein by reference as if fully set forth. Giarratana, N. et al. revealed that free amino acid mixtures can emulate casein bio-availability in the blood stream. Other examples are seen with ingestion Arabic Gum, which causes significant reduction in the body mass index (Babiker, R. “Effects of Gum Arabic Ingestion on Body Mass Index and body Fat Percentage in Healthy Adult Females, Two-Arm Randomized, Placebo Controlled Double-Blind Trial” (2012″ Nutrition J. 11: 111-118, which is incorporated herein by reference as if fully set forth).

Even when it is known that a dietary fiber promotes satiation and satiety and alters glycemic index, it may be necessary to improve the composition. A mixture of lipids with one amino acid has been published RU2356247C2, which is incorporated herein by reference as if fully set forth. More complex combinations as supplements in powder form with fiber, grains, and gums have also been proposed. See US20080003265A1, which is incorporated herein by reference as if fully set forth. The fortification of hydrolyzed protein has been reported by others (See WO2019/169433A1, U.S. Pat. No. 7,247,336B1, US20140154358A1, which are incorporated herein by reference as if fully set forth). Still, these bars or powders do not mimic the amino acid profile of proteins like salmon, steak, and others with high essential amino acid content.

### SUMMARY

In an aspect, the invention relates to a meal mimic. The meal mimic is in the form of a solid mass and comprises at least one source of peptides or amino acids, a ratio of calories to weight of 4.8 Cal/g or higher, and a volume equivalent to a cube of 0.8 to 1.3 inch per side.

In an aspect, the invention relates to meal mimic. The meal mimic is in the form of a solid mass and comprises at least one source of peptides or amino acids. The at least one source of peptides or amino acids has an amino acid content mimicking an amino acid content of a target protein.

In an aspect, the invention relates to a method of making the meal mimic. The method comprises: emulsifying oils and water without an emulsifier, adding at least one of fiber from a vegetable source, vitamins, and minerals while continuing emulsifying, blending in starches, peptides and/or amino acids, citric acid, benzoic acid, adding sweetener, adding liquid gelatin of 200 to 300 bloom, agitating vigorously, adding vegetable color and extra flavor, casting the liquid mixture obtained in molds, solidifying, and uncasting the meal mimic from the molds. In an aspect, the invention relates to a meal mimic prepared by this method.

### BRIEF DESCRIPTION OF THE DRAWING

The FIGURE compares the amino acid profile of a salmon protein meal (solid line) to meal mimic (broken line).

### DETAILED DESCRIPTION

Certain terminology is used in the following description for convenience only and is not limiting. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

As used herein amino acid “content” means the type of amino acids present in a given protein.

As used herein amino acid “profile” means the ratio of amino acids to one another in a given protein. Where a mass of a given protein is known, the amino acid “profile” may be the mass of each amino acid present in the given mass of protein.

Embodiments herein may accurately replicate real food meals (calories, amino acid profile, carbohydrates, fats, micronutrients, minerals etc.). This may be packaged in a nice tasting small mass; e.g. (but not limited to), a cube ranging from 0.5 inches to 1.5 inches cubed. The cube may be 1 inches to 1.5 inches cubed. The small mass may have other geometric forms. The volume of the small mass having a geometric shape other than a cube may be like that of a cube ranging from 0.5 inches to 1.5 inches cubed or 1 to 1.5 inches cubed. Embodiments may provide perfect nutrition in a convenient method. The meal cube may have a high caloric density. A high caloric density may be above 4 Cal/g or higher. A high caloric density may be an average value of 5.3 Cal/g or higher.

An embodiment comprises a meal mimic. The meal mimic may also be referred to as a meal in a pill, a meal cube, MealCube™, a concentrated food, Meepo™, or the like. A meal mimic may provide excellent nutrition, might be consumed within seconds, could have a 10× reduction in weight/size compared to other products, may be easily shipped around the world, and/or may have a shelf-life of 3 years+.

A meal mimic may have any shape. The meal mimic may be a solid mass in the form of a cube, a cuboid, a parallelepiped, a sphere, or a spheroid. Other shapes are also contemplated; e.g. but not limited to, stars, half spheres, diamonds, etc. The size of a cube shaped meal mimic may be 1.3 in to 0.8 inch per side. The size of a cube shaped meal mimic may be 1.5 in to 0.8 inch per side. This size of a meal mimic may be such that it may be consumed in one to three bites by an average individual. This size of a meal mimic may be tailored to the type of individual receiving it such that the type of individual receiving it may be consume it in one to three bites. This size of a meal mimic may be such that it may be consumed in one bite by an average individual. This size of a meal mimic may be tailored to the type of individual receiving it such that the type of individual receiving it may be consume it in one bite. This size of a meal mimic may be such that it may be consumed quickly by an average individual. This size of a meal mimic may be tailored to the type of individual receiving it such that the type of individual receiving it may be consume it quickly.

A meal mimic may have a ratio of calories to its weight of approximately 4 to 6 Cal/g. A meal mimic may have a ratio of calories to its weight of approximately 6 to 8 Cal/g. The methods herein may achieve this ratio.

A meal mimic may comprise a combination of gelatin and fibers. A meal mimic may comprise a combination of two or more of gelatin, gellan, hydrolized collagen or peptides to produce a matrix to encapsulate complex molecules lipids carbs and free molecules as amino acids, gelatin, and fibers. The constituents may be condensed with macro and micronutrients in the meal mimic to emulate a real meal. A meal mimic may comprise peptides or free amino acids.

The meal mimic may be a solid food that is a concentrated food, and replicates a meal in terms of macro and micro components. The meal mimic may be highly caloric and may have many applications as food on the go, especially for the army, special forces, outdoor sports, malnutrition cases, nursing homes, hospitals for those with a lack of appetite and the general public (for example, but not limited to, gym goers, busy professionals, health-advocates). An embodiment comprises a method of treating an individual in need of a compact meal comprising administering any meal mimic herein to the individual. The individual may be one taking meals on the go. The individual may be in the army, special forces, etc. The individual may be a participant in sports; for example, but not limited to, outdoor sports. The individual may be malnourished. The individual may be a resident in a nursing home or hospital. The individual may be one with a lack of appetite. The individual may be one in bariatric control. The individual may be in the general public.

The texture of a meal mimic may be chewy. A meal mimic may have concentrated flavors. One or more flavors may be chosen from a wide spectrum of flavors. The one or more flavors may be selected from, but are not necessarily limited to, orange, cherry, lemon, and strawberry.

The meal mimic may be flameless and may not need further preparation. As used herein, “flameless” means the meal mimic does not need to be cooked prior to consumption. I may also mean that the meal mimic is resistant to flame. The meal mimic is a new solid food. It may be a complete meal ready to eat based on building blocks. The building blocks may be polysaccharides, peptides, amino acids, lipids, minerals, and vitamins

The following meal mimic may offer perfect nutrition based on building blocks contained and concentrated in meals like salmon, sweet potatoes, kale, and avocado. The meal mimic may be a concentrated food replicating a meal based on its amino acid profile, carbohydrate content without reducing sugars, lipid content, minerals, and vitamins The meal mimic may be in a concentrated cube between 0.8 to 1.3 in. The meal mimic may be in a concentrated cube between 0.8 to 1.5 in.

Some of the classical ingredients of the recipe, but not limited to them, are:
10 g to about 30 g of an amino acid mix to replicate the profile of animal protein;
10 g to about 30 g of an amino acid and peptide mix to replicate the profile of animal protein;
from about 10 to 20 g of peptides from hydrolyzed collagen to replicate amino acid profile of animal protein as a base to complement through the addition of amino acids (the collagen may come from animal or bacterial fermentation, for example as described in US 10155793B2, which is incorporated herein by reference as if fully set forth, to produce vegan versions of the meal mimic);
from about 10 mg to about 1g of a flavoring;
from about 100 mg to about 3000 mg of bio-available hydrophobic and hydrophilic Vitamin A, Vitamin B, Vitamin D, Vitamin E, Vitamin K, calcium, Boron, selenium and fats suspended in emulsion stabilized by starches from tapioca or any other source;
and polysaccharides as emulsifiers and as carbohydrate components.

In these, the components of the meal mimic accomplish nutrition but also are functional to provide the shape and stability of a cube. The shape may be a cube, but is not limited to this form. The preparation may be a super highly concentrated food mimic in the range of 100 to 500 Calories. However, the calories are not empty as the meal mimic replicates complete meals.

A meal mimic may comprise from 1 to 5 g of gelatin from 250 to 300 bloom grade. A meal mimic may comprise a bitter blocker composition. The bitter blocker may be from 1 to 5 g of commercial TrueClear® and/or a natural bitter blocker. The natural bitter blocker may be arabic gum. The natural bitter blocker may be made of dry mushrooms; e.g., from 0.5 to 5 g (mushrooms are dry in classical dryers from 100 to 150 ° F. from 10 to 25 hours). The bitter blocker combination allows the meal mimic to block the amino acid bitterness. However, the implementation of single components as the commercial bitter blocker or the mushroom concentrated can be used to diminish the bitterness.

TrueBlock® and TrueClear® are a plant-based bitter blockers. TrueBlock® and TrueClear® contain several known bitter blockers. The bitter blockers in these products include arabic gum and cherry extract. The official website of TrueClear® is https://tastesnatural.com/products/truclear/, which was accessed on Jul. 8, 2019 and is incorporated herein by reference as if fully. The official website of TruBlock® is set forth. https://tastesnatural.com/products/trublock/ and is incorporated herein by reference as if fully. The TruBlock™ Core and TruBlock™ Ultra Powder MSDS shows that they comprises 78-95% acacia gum, 1-6% flavor extracts, and 2-15% acerola cherry extract. A meal mimic may comprise TrueBlock®, TrueClear®, TruBlock™ Core, or TruBlock™ Ultra Powder. The amount of TrueBlock®, TrueClear®, TruBlock™ Core, or TruBlock™ Ultra Powder in a meal mimic may be 1 to 5 g.

A bitter blocker may also comprise mushrooms, which are also rich in nucleotides. “Mushroom's nucleotides encompass the 5′-adenosine monophosphate (5′-AMP), 5′-cytosine monophosphate (5′-CMP), 5′-guanosine monophosphate (5′-GMP), 5′-inosine monophosphate (5′-IMP), 5′-uridine monophosphate (5′-UMP), and 5′-xanthosine monophosphate (5′-XMP)” (See Chia-Wei Phan, et al. “A Review on the Nucleic Acid Constituents in Mushrooms: Nucleobases, Nucleosides and Nucleotides” (2018) Critical Reviews in Biotechnology 38:5 762-777, which is incorporated by references as if fully set forth). See also: Ming, D. et al. “Blocking Taste Receptor Activation of Gustducin Inhibits Gustatory Responses to Bitter Compounds” (1999) Proc. Natl. Acad. Sci. USA 96: 9903-9908, which is incorporated by references as if fully set forth.

The mushrooms may be Pleurotus Ostreatus. The mushrooms may be Agaricus bisporus. Other mushrooms may be the mushrooms. The mushrooms may be dried at 130° F. for 15 hours using a commercial food dryer. The dried mushroom may be ground to a powder. The dried mushroom, preferably as a powder, may be used as a bitter blocker herein.

Mushrooms or sources in the following articles may be used as the mushrooms for a bitter blocker: (1) Kim, M.S. and Kim, G. H. “Contents of Nucleic Acids (Nucleosides and Mono-Nucleotides) in Extracts of Pleurotus ostreatus, Agaricus bisporus and Flammulina velutipes” (2010) Korean J. Food & Nutr. 23 (3): 376-380; (2) Phan, C. et al. “A Review on the Nucleic Acid Constituents in Mushrooms: Nucleobases, Nucleosides and Nucleotides” (2018) Critical Rev. in Biotechnology 38: (5): 762-777, both of which are incorporated herein by reference as if fully set forth.

Any other organic source or substance rich in nucleosides or nucleotides may be a bitter blocker.

The meal mimic may comprise added flavoring. The flavorings are added through natural oils which can be USDA approved or not such as mulberry, raspberry, lime, lemon, or orange, without limitation.

The flavors for orange may be between 10 mg to 25 mg. Now we also rely on organic oils approved by USDA; therefore, also FDA approved. The organic oils can reach 1 or 2 grams per pill.

Natural or artificial FDA approved flavors like mulberry, raspberry, Lime, lemon, orange, chocolate, vanilla flavoring, strawberry, apple, kiwi, banana, coconut, caramel, grape, blueberry, tangerine peanut and nut butter, almond flavoring, tart cherry, coffee, cinnamon, ginger, nutmeg, clove, ginger, peach, pear, or other any herbs, nuts and fruits may be used in a meal mimic.

The meal mic may comprise vitamins and/or minerals.

Vitamin B may be used, at a preferred dosage from about 5 mg to about 600 mg Vitamin B. The preferred Vitamin B is a Vitamin B complex. The Vitamin B complex may include two or more of thiamine (Vitamin B1), riboflavin (Vitamin B2), niacin (Vitamin B3), pyridoxine (Vitamin B6), folic acid (Vitamin B9), cyanocobalamin (Vitamin B12), pantothenic acid, and biotin. The Vitamin B family is found in meat, chicken, and fish in different composition and the meal mimic may replicate these sources inside of the meal in a pill composition.

When Vitamin C is used, the preferred dosage is from about 100 mg to about 2,800 mg. Vitamin C is used as ascorbic acid. Vitamin C is naturally found in citrus fruits, such as oranges, grapefruit, lemons, mangos, and the like, and in many green vegetables, such as asparagus, broccoli, spinach, green peppers, and peas, tomatoes, potatoes, and cabbage. The Vitamin B family is found in fruits and vegetables in different composition and the meal mimic may replicate this inside of the meal in a pill composition.

When Vitamin E is used, the preferred dosage is from about 40 mg to about 6000 mg. Vitamin E may be a preservative and antioxidant. and also to replicate the vitamin E found in natural food; e.g., wheat germ oil, fats, nuts and seeds, whole grains, egg yolks, avocado, and other vegetables.

When Vitamin K is used, the preferred dosage is from about 10 μg to about 150 μg.

When Vitamin A is used, it can be added at a preferred dosage from 250 mg to 15,000 mg of Vitamin A. Vitamin A is fat-soluble vitamin.

When Vitamin D is used, the dosage is preferably between 50 μg to 700 μg, expecting to supply biological functions cover with the vitamin D content in food.

The preferred oils are considered as healthy oils. Healthy oils include those with health benefits. The health benefits may be low LDL and cardioprotective effects. Healthy oils may be coconut oil, avocado oil, and other vegetable oils. Regarding the Omega 3, 6 and 9, a meal mimic may comprise flaxseed oil as the main source, but other vegetable oils may be used for this matter; e.g., but not limited to, sesame seed oil, walnut oil, nut oil combinations, and pumpkin seed oil. Also, fish oil can be used for the formulation. The fish oil may be refined or purified fish oil.

An embodiment provides a method of making a meal mimic. The method may comprise emulsifying the ingredients of a meal mimic and then solidifying the emulsion. Solidifying may be through gelatinization (also referred to as gelation). Drying may also occur. Some ingredients of the meal mimic may be added before emulsifying begins; for example an aqueous and oily ingredient that will form the base of an emulsion. Some ingredients may be added during emulsifying. Some ingredients may be added after emulsifying, but before solidifying. The method may comprise emulsifying at least one source of peptides or amino acids and solidifying the emulsion.

Ingredients may be incorporated before emulsion targeting entrapment of sensitive molecules such as vitamins and amino acids. The emulsion may be performed with sunflower oil, canola oil, olive oil among others. Wax may be included during emulsification, and may increase the melting point of the oil content. Non-limiting examples of wax from different sources that may be included during emulsification are beeswax and Carnauba Wax. After the emulsion is formed, carbohydrate sources can be added (e.g., but not limited to, hydrolyzed rice). Also, hydrolyzed proteins, in general, modified starches and common starches can be added. During the gelation process gums form a matrix that encapsulates the free amino acid and may also be peptides that equalize the amino acid profile of the target protein (such peptides and amino acids are mostly essential amino acids). The gelation complex may be added/present to stabilize the emulsion. Gums that may be added include but are not limited to xanthan, Arabic gum, the bitter blockers, and guar gum. Also, different flavor and unflavored gelatins can be used.

### EMBODIMENTS LIST

The following lists of embodiments includes certain embodiments within the scope of the invention. These listings do not, however, limit the invention to only those embodiments in the listings.

A. A meal mimic (also referred to as a food product or a solid food product, and is preferably a cube) in the form of a solid mass comprising at least one source of peptides from hydrolyzed collagen, rice, wheat but not necessarily limited to them. The solid mass may also comprise free amino acids as building blocks. The solid mass may also comprise free amino acids or peptides as building blocks. The free amino acids may be free of reducing sugars. The solid mass may also comprise starches of different sources and lipids from vegetable sources or isolated from fish, animals, and vegetables are used.

B. The meal mimic according to embodiment A, wherein the free amino acids comprise reactive amino acids, and the reactive amino acids are selected from alanine, arginine, asparagine, asp artate, citrulline, cysteine, glutamate, glutamine, glycine, histidine, hydroxyproline, hydroxyserine, hydroxylysine, isoleucine, leucine, lysine, methionine, phenylalanine, proline, serine, taurine, threonine, tryptophan, tyrosine, and valine. The free amino acids may comprise a hydrolysate from, but not limited to those from, collagen, rice, and wheat. The hydrolysates may mimic a protein from an animal source. The animal source may be but is not limited to cow, goat, salmon, fish, and chicken. Collagen purified from bacteria fermentation, for example as described in US 10155793B2, which is incorporated herein by reference as if fully set forth, is also an option to equalize the protein content.

C. The meal mimic according to embodiment A, wherein the solid food product mimics the profile of classical protein source to provide a full meal between 100 to 500 Cal.

D. The meal mimic according to embodiment A, also comprising purified starches from different sources. The sources include but are not limited to potato, sweet potato, and tapioca. The starch composition may be obtained with oligosaccharides as amyloses and amylopectin from different vegetable sources.

E. The meal mimic according to embodiment D comprising 10-20 grams of carbohydrates with a glycemic index similar to those from and with the aim of supplying the carbohydrates found in a meal including sweet potato, kale, and/or avocado.

F. The meal mimic according to any one of embodiments A to E wherein the solid food product has good stability of the amino acids and hydrolyzed peptides after about 36 months in the proper packaging. The solid food product may further comprise stabilizers. The stabilizers may be but are not limited to those selected from citric acid, benzoic acid, and vitamin E. These are recognized as GRAS molecules by the FDA.

G. The meal mimic according to embodiment A, wherein each serving size could be a cube preferentially but other forms can be used. The solid food may resemble a jelly and comprises from about 10 g to about 35 g of the bio-available amino acid and peptides.

H. The meal mimic according to embodiment A, where each serving size provides with 10 to 30 g of lipids from different oils like avocado, coconut, and flaxseed, but not limited to these oils.

I. The meal mimic according to embodiment A, further comprising at least one source of protein that is low in reducing sugars, and sugar substitutes like stevia, sucralose, mannitol but not limited to these sweeteners.

J. The meal mimic according to embodiment A further comprising a binder. The binder may be produced by a process of emulsification. The process used may be that outlined in the following lines. An emulsification may be performed using the oil content and water comprising the amino acids, micro nutrients and starch source (for example, tapioca) is used to obtain a proper emulsion. A step is the integration of all the solids; i.e., the addition of powdered ingredients, in the emulsion to increase the nutritional value of the mixture and the caloric content. The mixture may be shrunk by a solidification process performed with collagen or gelatine 300 Bloom or superior and pure gellan gum low acyl mixture. The mixture may be shrunk by a solidification process performed with collagen or gelatine 300 Bloom or superior and carboxymethyl cellulose (CMC) mixture. In the end, a super dense solid food is obtained. The solid food may mimic a meal like salmon, avocado, kale, and sweet potato. The meal mimicked is not, however, limited to this balanced meal. Until now, there was no meal replacement, canned meal, or protein bar with the high nutritional and caloric properties of the meal in pill described in the present document.

In the process above, oils and water may be first emulsified without an emulsifier. Then fiber from a vegetable source may be added and the emulsification procedure continued together with addition of vitamins and minerals. The emulsion obtained may be is blended with starches, peptides, and amino acid, citric acid, benzoic acid, preferably at 60° C.

Sweeteners used may be but are not limited to stevia, erythritol, sucralose, and glycyrrhizic acid. Stabilizers may be added, and may be but are not limited to one or more of cellulose, methyl-cellulose, and ethyl-cellulose.

Liquid Gelatin from 200 to 300 bloom may be added to the mixture, and the mixture then agitated vigorously.

Vegetable color and the extra flavor may be added. The extra flavor may be from essential oils from fruits like orange, lime, mango but not limited to these flavors.

The liquid mixture may be cast on molds with cube shape of 0.5 to 1.5-inch side.

Solidification may be performed at 0° C. for 45 minutes.

The cubes may be cast out from the molds. The meal mimic, or meal in a pill, may be ready to eat at this point.

K. A meal mimic may be a cube, or any other shape, and may mimic a salmon meal or a steak meal.

L. A method for making the bitterness of amino acids in the solid food product has been developed which improved stability of an amino acids mix. The method comprises: combining the amino acids with tapioca flour or starches from different sources and bitter blockers from natural sources as True Clear and a special composition of dried mushrooms. Altogether the process blocks substantially the bitterness of amino acids like valine, leucine, isoleucine, cysteine among others. The arrangement also avoids the formation of reactive compounds with free sugars and improves the bioavailability of solid food. This method may be used in conjunction with a method of making a meal mimic.

M. A sweet flavor is provided to the product of the above embodiments. The sweet flavor may be provided by a mixture of sweeteners like sucralose, stevia, and mannitol but not limited to them.

N. The product of the above embodiments may be a super high caloric solid food which is achieved by emulsification and solidification techniques with 350-300 boom gelatine integrated with different cellulose. The product of the above embodiments may be a super high caloric solid food which is achieved by emulsification and solidification techniques with 250-300 boom gelatine integrated with different cellulose. For instance, the density of the solid food may be between 2 and 4 g/ml vs 0.9 of coconut oil or 1 g/ml of water. Or the density of the solid food may be 1.7 g/ml vs 0.9 of coconut oil or 1 g/ml of water. In other words, the meal mimic, which may be called meal in a pill, has more packed into it in terms of calories compared to simple oils.

O. With the proper additives; for example but not limited to, citrate, ascorbic acid, and benzoic acid, and storage, the product of the above embodiments may be stable up to three years inside of its unopened package. The water activity of the meal mimic may be below between 0.2 to 0.4, which makes this product shelf-life stable.

Still further embodiments include, but are not limited to the following.

1. A meal mimic in the form of a solid mass comprising at least one source of peptides or amino acids and a ratio of calories to weight of 4.8 Cal/g or higher, 5 Cal/g or higher, 5.3 Cal/g or higher, 4.8-5 Cal/g, 4.8 Cal/g, 5 Cal/g, or 5.3 Cal/g. The meal mimic may tune to any other protein as meat, chicken or salmon; i.e., it may have an amino acid composition mimicking natural protein sources.

2. The meal mimic of embodiment 1, wherein the solid mass is a cube, preferably 1.3 in to 0.8 inch per side, or 1.5 in to 0.8 inch per side, a cuboid, a parallelepiped, a sphere, or a spheroid.

3. The meal mimic of embodiments 1 or 2, wherein the source of peptides or amino acids comprises at least one of hydrolyzed collagen, rice, wheat, and free amino acids.

4. The meal mimic of any one or more of embodiments 1-3, wherein the peptides or amino acids are building blocks.

5. The meal mimic of any one or more of embodiments 1-4, wherein the at least one source of peptides or amino acids is free of reducing sugars.

6. The meal mimic of any one or more of embodiments 1-5 further comprising starch.

7. The meal mimic of embodiment 6, wherein the starch comprises more than one type of starch, where at least one type of starch, preferably each type of starch, in the more than one type of starch has a ratio of amylose to amylopectin different than all other types of starch in the more than one type of starch. Non-limiting examples of a starch for a meal mimic include tapioca starch, potatoes starch, sweet potato starch, waxy corn starch, modified tapioca starch, and modified corn starch. Non-limiting examples of more than one type of starch include two or more of starch for a meal mimic include tapioca starch, potatoes starch, sweet potato starch, waxy corn starch, modified tapioca starch, and modified corn starch.

8. The meal mimic of embodiment 7, wherein at least one starch in the more than one type of starch is from a different source than other starches in the more than one type of starch. The sources may be but are not limited to tapioca, potato, sweet potato, and waxy corn starch, modified tapioca starch, and modified corn starch.

9. The meal mimic of embodiment 8, wherein each type of starch in the more than one type of starch is from a different source than every other type of starch in the more than one type of starch.

10. The meal mimic of any one or more of embodiments 1-9 further comprising lipids.

11. The meal mimic of embodiment 10, wherein the lipids are from at least one of vegetables, fruits, fish, land animals, coconut oil, avocado oil, flaxseed oil or olive oil, and/or the meal mimic comprises at least one of vegetable oil, fruit oil, fish oil, land animal oil, coconut oil, avocado oil, flaxseed oil or olive oil.

12. The meal mimic of any one or more of embodiments 1-11, wherein the amino acids comprise one or more reactive amino acids selected from the group consisting of alanine, arginine, asparagine, aspartate, citrulline, cysteine, glutamate, glutamine, glycine, histidine, hydroxyproline, hydroxyserine, hydroxylysine, isoleucine, leucine, lysine, methionine, phenylalanine, proline, serine, taurine, threonine, tryptophan, tyrosine, and valine. The choice and/or amounts of the foregoing may mimic the amino acid kind, ratios, or amounts in a target protein. The target protein may be any desired protein. The target protein may be any protein listed herein.

13. The meal mimic of any one or more of embodiments 1-12, wherein the solid mass comprises hydrolysates.

14. The meal mimic of embodiment 13, wherein the hydrolysates are from collagen, from rice, and/or mimic protein from one or more animal sources.

15. The meal mimic of embodiment 14, wherein the animal sources are selected from the group consisting of cow, goat, salmon, fish, chicken, and classical protein sources. As used herein, “classical protein sources” refers to those used in protein bars, including but not limited to whey protein isolate, hydrolyzed whey protein, milk protein isolate, soy protein isolate, pea protein isolate]

16. The meal mimic of any one or more of embodiments 1-15, wherein the mimic comprises a profile of a classic protein source.

17. The meal mimic of any one or more of embodiments 1-16, wherein the mimic comprises from 100 to 500 Cal.

18. The meal mimic of any one or more of embodiments 1-17 comprising purified starches from different sources.

19. The meal mimic of embodiment 18, wherein the different sources are at least two of potato, sweet potato, and tapioca.

20. The meal mimic of embodiment 19, wherein the purified starches comprise oligosaccharides.

21. The meal mimic of embodiment 20, wherein the oligosaccharides are one or more selected from amylose, amylopectin, fructo-oligosaccharides, and inulins.

22. The meal mimic of embodiment 21, wherein the oligosaccharides are from different vegetable sources.

23. The meal mimic of any one or more of embodiments 1-23, wherein the mimic comprises 10-20 grams of carbohydrates.

24. The meal mimic of embodiment 23, wherein the meal mimic has a glycemic index mimicking a meal comprising at least one of sweet potato, kale, or avocado. For example, boiled sweet potato has a glycemic index of around 40-50, kale has low carbohydrate content and has a glycemic index of around 2-4, avocado is mostly fat and has a glycemic index of around 10-20.

25. The meal mimic of embodiment 24 or 24, wherein the carbohydrates mimic those found in a meal including at least one of sweet potato, kale, or avocado.

The amino acid composition of a meal mimic may have approximately 90% similarity, or 80-90% similarity, with salmon. The macronutrients of a meal mimic may be similar to 22 g protein, which mimics 100 g of salmon, 20 g of carbohydrates which are obtained in 100 g of sweet potato, 20 g of lipids, which includes 10 g of saturated fat, 3 g of unsaturated fat and 7 g of monounsaturated fat, which matches the lipid composition of half avocado and the 100 g of salmon together with 5 g of fibers to match the kale fiber content. All these together with the micronutrients provided by these ingredients are summarized in the FIGURE and Example 12.

26. The meal mimic of any one or more of embodiments 1-25, wherein the peptides or amino acids are stable for at least about 36 months in the proper packaging. As used herein, “proper packaging” means vacuum sealed packed or nitrogen purged, and storage at 20° C.

27. The meal mimic of any one or more of embodiments 1-26 further comprising one or more stabilizer.

28. The meal mimic of embodiment 27, wherein the one or more stabilizer is selected from citric acid, benzoic acid, or vitamin E.

29. The meal mimic of any one or more of embodiments 1-28, wherein the solid mass is in the form of a cube.

30. The meal mimic of any one or more of embodiments 1-29, wherein the solid mass resembles a jelly.

31. The meal mimic of any one or more of embodiments 1-30 comprising from about 10 g to about 35 g of bio-available peptides and amino acids.

32. The meal mimic of any one or more of embodiments 1-31 comprising 10 to 30 g of lipids.

33. The meal mimic of embodiment 32, wherein the lipids are from different oils.

34. The meal mimic of embodiment 33, wherein the different oils are selected from avocado, coconut, and flaxseed.

35. The meal mimic of any one or more of embodiments 1-34 further comprising at least one source of protein.

36. The meal mimic of embodiment 35, wherein the source of protein is low in reducing sugars.

37. The meal mimic of any one or more of embodiments 1-36 further comprising one or more sugar substitute.

38. The meal mimic of embodiment 37, wherein the one or more sugar substitutes are selected from stevia, sucralose, mannitol.

39. The meal mimic of any one or more of embodiments 1-38 further comprising a binder.

A meal mimic may include a mix of gelatin/gellan. The ratio of gelatin/gellan may be in a range from 4 to 6, preferably about 5. When the ratio moves to six the cube gets harder and when it is moved to 4 it gets softer]

40. The meal mimic of embodiment 39, wherein the binder is formed by a process of emulsification.

41. The meal mimic of embodiment 40, wherein the emulsification is performed with a mixture of water and the oil, peptides, amino acids, micro nutrients, and starch.

42. The meal mimic of embodiment 41, wherein the starch is tapioca starch.

43. The meal mimic of any one or more of embodiments 40-42, wherein emulsification is conducted for 20 minutes.

44. The meal mimic of any one or more of embodiments 40-43, wherein emulsification is conducted until a homogenous phase is obtained.

45. The meal mimic of any one or more of embodiments 40-44, wherein after emulsification one or more of the following are added: an amino acid mix, vitamins, minerals, starch, artificial flavors, citric acid, benzoic acid, sucralose, and collagen.

46. The meal mimic of any one or more of embodiments 40-45, wherein shrinking and solidification follow emulsification and addition.

47. The meal mimic of embodiment 46, wherein the solidification is conducted with collagen or gelatine 300 Bloom or superior and a carboxymethylcellulose (CMC) mixture, or superior and a Low acyl gellan mixture.

48. The meal mimic of any one or more of embodiments 1-47, wherein the solid mass is super dense, preferably 1.3 to 3 or 4 g/ml or 1.3 to 1.7 g/ml.

49. The meal mimic of embodiment 48, wherein super dense is achieved by the gelatine and mixing until a homogeneous, heavy product obtained.

50. The meal mimic of any one of embodiments 40-49, wherein casting in molds follows achieving a super dense product.

51. The meal mimic of any one of embodiments 1-50 mimicking a meal of salmon, avocado, kale, and sweet potato.

52. A method of making the meal mimic of any one of embodiments 1-51 comprising:
emulsifying oils and water without an emulsifier,
adding at least one of fiber from a vegetable source, vitamins, and minerals while continuing emulsifying,
blending in starches, peptides and/or amino acids, citric acid, benzoic acid,
adding sweetener,
adding liquid gelatin of 200 to 300 bloom,
agitating vigorously,
adding vegetable color and extra flavor,
casting the liquid mixture obtained in molds,
solidifying, and
uncasting the meal mimic from the molds.

53. The method of embodiment 52, wherein the blending in step is performed at 60° C.

54. The method of any of claim 52 or 53, wherein the sweetener is at least one of stevia, sucralose, or glycyrrhizic acid.

55. The method of any one or more of embodiments 52-54 further comprising adding stabilizers preferably after the adding sweetener step and more preferably after the adding sweetener step and before the adding liquid gelatin step.

56. The method of any one or more of embodiments 52-55 further comprising adding at least one of cellulose, methyl-cellulose, ethyl-cellulose, oleo-gel, or beeswax, preferably after the adding sweetener step and more preferably after the adding sweetener step and before the adding liquid gelatin step.

57. The method of any one of embodiments 52-56, wherein the extra flavor is selected from essential oils from one or more fruit.

58. The method of embodiment 57, wherein the one or more fruit are selected from orange, lime, and mango.

59. The method of any one or more of embodiments 52-58, wherein the solidifying comprises gelation at 0° C. for 45 minutes.

60. The meal mimic of any one of embodiments 1-51 or the meal mimic prepared by the method of any one of embodiments 52-59, wherein the meal mimic is a pill is ready to eat.

61. The meal mimic of any one of embodiments 1-51 or the meal mimic prepared by the method of any one of embodiments 52-59, wherein the meal mimic mimics a salmon meal or a steak meal.

62. A method for ameliorating bitterness in the meal any one of embodiments 1-51 or the meal mimic prepared by the method of any one of embodiments 52-59 comprising: combining the peptides or amino acids with tapioca flour or starches from different sources and bitter blockers from natural sources.

63. The method of embodiment 62, wherein the bitter blockers comprise True Clear and/or a composition of dried mushrooms.

64. The meal mimic of any one of embodiments 1-51 or the meal mimic prepared by the method of any one of embodiments 52-59, wherein the meal mimic has a sweet flavor.

65. The meal mimic of any one of embodiments 1-51 and 64 or the meal mimic prepared by the method of any one of embodiments 52-59, wherein the meal mimic is high caloric.

66. The meal mimic of embodiment 65, wherein the meal mimic has a density from 4 g/ml, 2 g/ml, 2 to 4 g/ml, 1.3 g/ml, or 1.7 g/ml, or a density in range between any two of the foregoing densities.

67. The meal mimic of any one of embodiments 1-51, 64, 65, or 66, or the meal mimic prepared by the method of any one of embodiments 52-59, wherein the meal mimic is stable up to three years inside of its unopened package.

Still further embodiments include, but are not limited to the following.

I. A meal mimic in the form of a solid mass comprising at least one source of peptides or amino acids and a ratio of calories to weight of 4.8 Cal/g or higher and having a volume equivalent to a cube of 0.8 to 1.3 inch per side.

II. The meal mimic of embodiment I, wherein the source of peptides or amino acids comprises at least one of hydrolyzed collagen, rice, wheat, and free amino acids.

III. The meal mimic of one or both of embodiments I and II further comprising on or more of starch, lipids, oligosaccharides, and carbohydrates.

IV. The meal mimic of one or more of embodiments I-III wherein the at least one source of peptides or amino acids has an amino acid content mimicking an amino acid content of a target protein.

V. The meal mimic of one or more of embodiments I-IV further comprising a bitter blocker composition.

VI. The meal mimic of one or more of embodiments I-V, wherein the bitter blocker composition comprises one or more of natural bitter blockers, Arabic gum, dry mushrooms, plant based bitter blockers, TrueBlock®,TrueClear®, TruBlock™ Core, TruBlock™ Ultra Powder MSDS, and a combination of 78-95% acacia gum, 1-6% flavor extracts, and 2-15% acerola cherry extract.

VII. A meal mimic in the form of a solid mass comprising at least one source of peptides or amino acids, wherein the at least one source of peptides or amino acids has an amino acid content mimicking an amino acid content of a target protein. The meal mimic may be any meal mimic herein. The meal mimic may be one of one or more of embodiments I-VI.

VIII. The meal mimic of embodiment VII, wherein the target protein is one or more selected from the group consisting of fish, pork, egg, beef, pea, and salmon protein.

IX. The meal mimic of one or both of embodiments VII and VIII comprising hydrolysates from animal sources selected from the group consisting of cow, goat, salmon, fish, chicken, whey protein isolate, hydrolyzed whey protein, milk protein isolate, soy protein isolate, and pea protein isolate.

X. The meal mimic of one or more of embodiments VII-IX comprising a bitter blocker composition comprising one or more of natural bitter blockers, Arabic gum, dry mushrooms, plant based bitter blockers, TrueBlock®,TrueClear®, TruBlock™ Core, TruBlock™ Ultra Powder MSDS, and a combination of 78-95% acacia gum, 1-6% flavor extracts, and 2-15% acerola cherry extract.

XI. The meal mimic of one or more of embodiments VII-X further comprising one or more of starch, lipids, oligosaccharides, and carbohydrates.

XII. The meal mimic of one or more of embodiments VII-XI, wherein the meal mimic has a glycemic index mimicking a meal comprising at least one of sweet potato, kale, or avocado.

XIII. The meal mimic of one or more of embodiments VII-XII, wherein the carbohydrates mimic those found in a meal including at least one of sweet potato, kale, or avocado, or in a meal including steak and sweet potato.

XIV. The meal mimic of one or more of embodiments VII-XIV, wherein the peptides or amino acids are stable for at least about 36 months when vacuum sealed packed or nitrogen purged with storage at 20° C.

XV. A method of making the meal mimic comprising:

emulsifying oils and water without an emulsifier,

adding at least one of fiber from a vegetable source, vitamins, and minerals while continuing emulsifying,

blending in starches, peptides and/or amino acids, citric acid, benzoic acid,

adding sweetener,

adding liquid gelatin of 200 to 300 bloom,

agitating vigorously,

adding vegetable color and extra flavor,

casting the liquid mixture obtained in molds,

solidifying, and

uncasting the meal mimic from the molds.

The method may produce a meal mimic herein. The meal mimic may be one of the above embodiments.

XVI. The method of embodiment XV, wherein the blending in step is performed at 60° C.

XVII. The method of embodiment XV or XVI further comprising adding stabilizers.

XVIII. The method of one or more of embodiments VII-XVII further comprising adding at least one of cellulose, methyl-cellulose, ethyl-cellulose, oleo-gel, or beeswax, preferably after the adding sweetener step.

XIX. The method of one or more of embodiments VII-XVIII, wherein the extra flavor is selected from essential oils from one or more fruit.

XX. The method of one or more of embodiments VII-XIX, wherein the one or more fruit are selected from orange, lime, and mango.

XXI. The method of one or more of embodiments VII-XX, wherein the solidifying comprises gelation at 0° C. for 45 minutes.

XXII. A meal mimic prepared by the method of one or more of embodiments VII-XXI.

XXIII. The meal mimic of embodiment XXII, wherein the meal mimic mimics a salmon meal or a steak meal.

The following examples show the main ingredients and the micro ingredients inside of exemplary solid foods, which may be called meal in a pill or meal cube.

The implementation of several coated amino acids may be part of the recip. For example, branched amino acids (BCAA's) can be coated, for example, with one or more of inulin and soy lecithin, and incorporated to the amino acid blend. This also can be achieved by using a blend of peptides pre-coated. The pre-coating may be with one or more of inulin and soy lecithin, but not limited to these oligosaccharides, and fatty coatings.

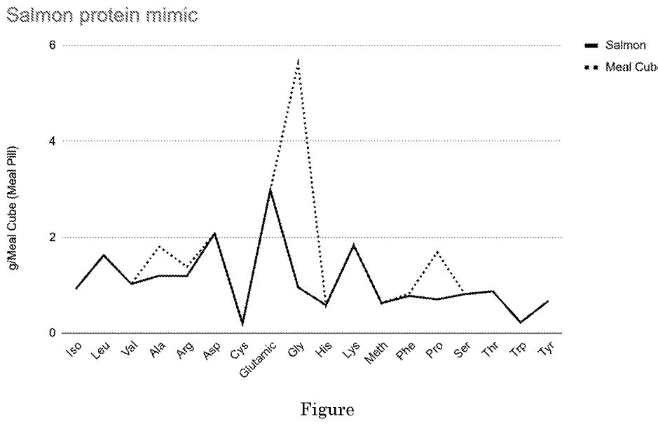

An exemplary Formula offers an overall amount of 20 to 25 grams of protein, see FIG. 1. Due to the equalization process, three amino acids, glycine, alanine, and proline, are in a higher concentration than in salmon. Nevertheless, these amino acids are part of gelatin and collagen and are entirely innocuous.

The skilled artisan will understand that the protein mimic can be achieved using hydrolyzed protein from different sources like, but not limited to, fish, pig, egg, pea protein. Embodiments include hydrolyzed protein from one or more of these sources. Additionally, further fortification of the protein mimic can be achieved using free amino acids and peptide blends.

### EXAMPLE 1

### A Salmon Meal Mimic

| | | |
|---|---|---|
| Hydrolyzed collagen as based to mimic salmon amino acid | 16 | g |
| profile | | |
| Tapioca flour | 6 | g |
| Pectin High methoxy | 1 | g |
| Coconut oil | 14.3 | g |
| Avocado oil | 3.5 | g |
| Flaxseed oil | 3.5 | g |
| Carnauba wax | 1.5 | g |
| Benzoic acid | 0.2 | g |
| Amino acid or peptides mixture | | |
| Amino acids (peptides) mixture to mimic salmon profile | 7 | g |
| TruClear, TruBlock or another organic bitter blocker | 0.75 | g |
| Citrate as preservative | 0.6 | g |
| Mushroom powder | 5 | g* |
| Micronutrients to match Salmon, Avocado, Kale and sweet | 1.5 | g |
| potato | | |

(This could be in powder form or as gummies) As used herein, “match” means that the amount of the listed item(s) are the amounts reported the food. The micronutrients may be those in Examples 5, 5.1, or 12. The micronutrients may be the amounts and kind of micronutrients found in salmon, avocado, kale and sweet potato as reported by the USDA. For example the amount of micronutrients may those indicated in the Table of Example 12, which are for 100 g salmon, 50 g kale, and 100 g sweet potato.

| Polymer blend | | |
|---|---|---|
| Gelatin 250 to 300 bloom | 2.8 | g |
| Gellan Low acyl. | 0.5 | g |
| Glycerin | 9.4 | g |
| Ca₃(PO₄)₂ | 0.6 | g |
| KCl. | 0.2 | g |
| Water | 8 | g |
| Flavor mix | | |
| Concentrated natural orange flavor (terpenless) | 0.5 | g |
| Concentrated artificial flavor | 0.3 | g |
| Sweeteners | | |
| Sucralose | 0.075 | g |
| Glycyrrhizic acid | 0.020 | g |
| Erythritol. | 0.135 | g |

### EXAMPLE 1.1

### A Salmon Meal Mimic

| | | |
|---|---|---|
| Amino acids mixture to mimic salmon profile | 7 | g |
| Hydrolyzed collagen as based to mimic salmon amino acid | 3 | g |
| profile | | |
| Tapioca flour | 10 | g |
| Coconut oil | 5 | g |
| Avocado oil | 5 | g |
| Lemon oil | 1 | g |
| Orange oil | 3 | g |
| Gelatine 250 to 300 bloom | 6.25 | g |
| Dried mango as fiber | 5 | g |
| Citrate as preservative | 0.8 | g |
| Benzoic acid | 0.2 | g |
| True Clear or Other organic bitter blocker | 30 | mg |
| Mushroom powder | 5 | g* |
| Carnauba wax | 0.75 | g |
| Flaxseed oil | 1.45 | g |
| Micronutrients to match Salmon, Avocado, Kale and sweet | 1 | g |
| potato | | |

(This could be in powder form or as gummies) The micronutrients may be those in Examples 5, 5.1, or 12. The micronutrients may be the amounts and kind of micronutrients found in salmon, avocado, kale and sweet potato as reported by the USDA. For example the amount of micronutrients may those indicated in the Table of Example 12, which are for 100 g salmon, 50 g kale, and 100 g sweet potato.

| | | |
|---|---|---|
| Sucralose | 0.075 | g |
| Carboxymethyl-cellulose | 0.03 | g |

This example may be expanded to a broader range of constituents. The ranges follow.

### EXAMPLE 2

### A Steak Meal Mimic

| | | |
|---|---|---|
| Amino acids mixture to mimic salmon profile | 15 | g |
| Hydrolyzed collagen as based to mimic steak amino acid | 8 | g |
| profile | | |
| Tapioca flour | 5 | g |
| Coconut oil | 8 | g |
| Avocado oil | 5 | g |
| Lemon oil | 2 | g |
| Gelatine 250 to 300 bloom | 8 | g |
| Citrate as preservative | 0.8 | g |
| Benzoic acid | 0.2 | g |
| True Clear or Other organic bitter blocker | 150 | mg |
| Mushroom powder | 5 | g* |
| Carnauba wax | 1.75 | g |
| Micronutrients to match Steak and sweet potato | 0.5 | g |

(This could be in powder form or as gummies) The micronutrients may be those in Example 6. The micronutrients may be the amounts and kind of micronutrients found in steak and sweet potato, as reported by the USDA. For this case, the micronutrients match those for 20 g of steak and 100 g of sweet potato.

| | | |
|---|---|---|
| Sucralose | 0.05 | g |
| Carboxymethyl-cellulose | 0.03 | g |

### EXAMPLE 3

### An Amino Acid Profile of a Meal Mimic

| | beef steak | Collagen | Free amino acids |
|---|---|---|---|
| Alanine | 1.39 | 0.744 | 0.6506847721 |
| Arginine | 1.46 | 0.704 | 0.7538467507 |
| Aspartic Acid | 2.05 | 0.416 | 1.631643065 |
| Cysteine | 0.24 | 0.032 | 0.2052841901 |
| Glutamic Acid | 3.42 | 0.744 | 2.6795499515 |
| Glycine | 1.44 | 1.808 | |
| Histidine | 0.75 | 0.04 | 0.7085548012 |
| Isoleucine | 1.00 | 0.112 | 0.8874956353 |
| Leucine | 1.77 | 0.24 | 1.530242483 |
| Lysine | 1.89 | 0.4 | 1.4871774976 |
| Methionine | 0.59 | 0.048 | 0.544356935 |
| Phenylalanine | 0.88 | 0.152 | 0.7254393792 |
| Proline | 1.39 | 2.032 | |
| Serine | 0.90 | 0.248 | 0.649070805 |
| Threonine | 0.89 | 0.088 | 0.8005354025 |
| Tryptophan | 0.13 | 0 | 0.1263239573 |
| Tyrosine | 0.71 | 0.016 | 0.6915848691 |
| Valine | 1.11 | 0.168 | 0.9458700291 |
| TOTAL | 22 | 7.992 | 15.0176605238 |

### EXAMPLE 4

### An Amino Acid Profile of a Meal Mimic

| Salmon | | | Free amino |
|---|---|---|---|
| composition | g | Collagen(g) | acids (g) |
| Alanine | 1.2 | 1.8 | 0 |
| Arginine | 1.2 | 1.39 | 0 |
| Aspartic Acid | 2.08 | 1.4 | 0.68 |
| Cysteine | 0.12 | 0.028 | 0.18 |
| Glutamic Acid | 3.00 | 2.19 | 0.8 |
| Glycine | 1.00 | 5.00 | |
| Histidine | 0.60 | 0.42 | 0.17 |
| Isoleucine | 0.92 | 0.36 | 0.56 |
| Leucine | 1.62 | 0.70 | 0.93 |
| Lysine | 1.84 | 0.59 | 1.24 |
| Methionine | 0.628 | 0.15 | 0.1437106487 |
| Phenylalanine | 0.78 | 0.8 | 0.48 |
| Proline | 0.70 | 1.7 | |
| Serine | 0.816 | 0.61 | 0.20 |
| Threonine | 0.876 | 0.416 | 0.4599 |
| Tryptophan | 0.224 | 0 | 0.224 |
| Tyrosine | 0.676 | 0.38 | 0.296 |
| Valine | 1.03 | 0.4655 | 0.566 |
| Total | 19.4 | 19 | 6.7 |

### EXAMPLE 4.1

### An Amino Acid Profile of a Meal Mimic

| Salmon | | | |
|---|---|---|---|
| composition | g | Collagen | Free amino acids |
| Alanine | 0.55 | 0.651 | |
| Arginine | 0.52 | 0.616 | |
| Aspartic Acid | 0.95 | 0.364 | 0.3507554468 |
| Cysteine | 0.11 | 0.028 | 0.0520494492 |
| Glutamic Acid | 1.84 | 0.651 | 0.7109911873 |
| Glycine | 0.46 | 1.582 | |
| Histidine | 0.31 | 0.035 | 0.1625985312 |
| Isoleucine | 0.48 | 0.098 | 0.2285317013 |
| Leucine | 0.88 | 0.21 | 0.4018457772 |
| Lysine | 0.67 | 0.35 | 0.1948347613 |
| Methionine | 0.28 | 0.042 | 0.1437106487 |
| Phenylalanine | 0.54 | 0.133 | 0.2460873929 |
| Proline | 0.43 | 1.778 | |
| Serine | 0.49 | 0.217 | 0.1653936353 |
| Threonine | 0.41 | 0.077 | 0.1979860465 |
| Tryptophan | 0.11 | 0 | 0.0679314565 |
| Tyrosine | 0.42 | 0.014 | 0.2449659731 |
| Valine | 0.54 | 0.147 | 0.2386053856 |
| Total | 10.00 | 6.993 | 3.4062873929 |

### EXAMPLE 5

### A Micronutrient Mimic for a Salmon Meal Mimic

| | | | Vitamins and |
|---|---|---|---|
| | Total | | minerals |
| Calcium | 218.448 | mg | 150 |
| Iron | 5 | mg | 5 |
| Iodine | 32 | μg | 100 |
| Copper | 0.4 | mg | 0.4 |
| Magnesium | 180 | mg | 180 |
| Manganese | 0.1 | mg | 1 |
| Molybdenum | 50 | μg | 50 |
| Phosphorus | 396.325 | mg | 400 |
| Potassium | 300 | mg | 200 |
| Selenium | 60 | μg | 60 |
| Sodium | 124 | mg | 120 |
| Zinc | 4.5 | mg | 4.5 |
| Vitamin B1 | 0.5 | mg | 0.5 |
| Vitamin B2 | 0.7 | mg | 0.7 |
| Vitamin B3 | 10.7 | mg | 10.7 |
| Vitamin B6 | 1.0 | mg | 1.0 |
| Vitamin B12 | 3.2 | μg | 3.4 |
| Folate | 200 | μg | 220 |
| Pantothenic acid | 2.5 | mg | 2.6 |
| Vitamin C | 68.3278 | mg | 70 |
| Vitamin A (retinol) | 0.35 | μg | 0.35 |
| Vitamin D | 0 | mg | 25 |
| Vitamin E | 5 | mg | 6 |
| Vitamin K | 221.0132 | μg | 150 |
| Biotin | 0.03 | mg | 0.03 |

### EXAMPLE 5.1

### A Micronutrient Mimic for a Salmon Meal Mimic

| | | | Vitamins and |
|---|---|---|---|
| | Total | | minerals |
| Calcium | 218.448 | mg | 150 |
| Iron | 2.6372 | mg | |
| Iodine | 32 | μg | 100 |
| Copper | 0.110051 | mg | 1 |
| Magnesium | 56.131 | mg | 100 |
| Manganese | 0.54164 | mg | 2.5 |
| Molybdenum | 3.86 | μg | 50 |
| Phosphorus | 396.325 | mg | |
| Potassium | 689.466 | mg | 49.5 |
| Selenium | 43.6003 | μg | 100 |
| Sodium | 119.221 | mg | |
| Zinc | 0.64 | mg | 12.5 |
| Vitamin B1 | 0.154071 | mg | 50 |
| Vitamin B2 | 0.356749 | mg | 34.75 |
| Vitamin B3 | 9.02 | mg | |
| Vitamin B3 niacin | 14.65906 | mg | 86 |
| equivalents | | | |
| Vitamin B6 | 0.723349 | mg | 20.5 |
| Vitamin B12 | 5.67 | μg | 500 |
| Folate | 49.894 | μg | 667 |
| Pantothenic acid | 1.12979 | mg | 200 |
| Vitamin C | 68.3278 | mg | 500 |
| Vitamin A | 13274.544 | IU | |
| Retinol | 57.83 | μg | |
| Carotenoid RAE | 1686.821 | μg | 2250 |
| Vitamin D | 511.43 | IU | 400 |
| Vitamin E | 1.41422 | mg | 134 |
| Vitamin K | 221.0132 | μg | |
| Choline | 0.2835 | mg | |

### EXAMPLE 6

### A Micronutrient Mimic for a Steak Meal Mimic

| | Beef | | Vitamins and |
|---|---|---|---|
| | steak | | minerals |
| Vitamin E | 0.4 | mg | 134 |
| Vitamin K | 1.1 | μg | |
| Rivoflavin | 0.2 | mg | 34.75 |
| Niacin | 5.2 | mg | 86 |
| Vitamin B6 | 0.3 | mg | 20.5 |
| Folate | 6 | μg | 667 |
| Vitamin B12 | 2.5 | μg | 500 |
| Pantothenic acid | 0.6 | mg | 200 |
| Choline | 85.9 | mg | |
| Betaine | 7.2 | mg | |
| Minerals | | | |
| Calcium | 13 | mg | 150 |
| Iron | 2.6 | mg | 5 |
| Magnesium | 21 | mg | 100 |
| Phosphorus | 193 | mg | |
| Potassium | 300 | mg | 49.5 |
| Sodium | 61 | mg | |
| Zinc | 6.6 | mg | 12.5 |
| Copper | 0.1 | mg | 1 |
| Selenium | 21.6 | μg | 100 |
| Fluoride | 22.4 | μg | |

### EXAMPLE 7

### Salmon & Steak Meal Mimic (Optional, but not Limiting, Ranges

| | | |
|---|---|---|
| Amino acids mixture to mimic salmon & steak profiles | 3-15 | g |
| Hydrolyzed collagen as base to mimic salmon & steak | 7-13 | g |
| amino acid profile | | |
| Tapioca flour | 5-15 | g |
| Coconut oil | 5-20 | g |
| Avocado oil | 2-5 | g |
| Lemon oil | 1-2 | g |
| Orange oil | 1-3 | g |
| Gelatin 250 to 300 bloom | 5-9 | g |
| Carnauba wax | 0.5-2 | g |
| Citrate as preservative | 0.5-0.8 | g |
| Benzoic acid | 0.01-0.1 | g |
| True Clear or other organic bitter blocker, guar gum, | 30-200 | mg |
| xanthan gum and Arabic gum | | |
| Flaxseed oil | 1.45-3 | g |
| Micronutrients to match Salmon, Avocado, Kale and | 1-3 | g |
| sweet potato (or steak and sweet potatoes) | | |
| Sucralose | 0.03-0.075 | g |
| Artificial flavor | 0.1-0.4 | g |
| Carboxymethyl-cellulose | 0.03-0.05 | g |

### EXAMPLE 8

### A Salmon, Avocado, Kale and Sweet Potatoes Meal Mimic

| | | |
|---|---|---|
| Amino acids mixture to mimic salmon profile | 3 | g |
| Hydrolyzed collagen as base to mimic salmon & steak amino | 7 | g |
| acid profile | | |
| Tapioca flour | 10 | g |
| Coconut oil | 7.5 | g |
| Avocado oil | 2.5 | g |
| Lemon oil | 1 | g |
| Orange oil | 2 | g |
| Gelatin 250 to 300 bloom | 7 | g |
| Citrate as preservative | 0.8 | g |
| Benzoic acid | 0.01 | g |
| True Clear or other organic bitter blocker, guar gum, | 35 | mg |
| xanthan gum and Arabic Gum | | |
| Flaxseed oil | 1.5 | g |
| Micronutrients to match Salmon, Avocado, Kale and sweet | 3 | g |
| potato (or steak and sweet potatoes) | | |
| Sucralose | 0.04 | g |
| Artificial flavor | 0.2 | g |
| Bees Wax | 1.25 | g |

### EXAMPLE 9

Bitterness can be masked by different means. For instance, WO2013006305A1 shows different variations from alpha-tocopherol, beta-tocopherol, gamma-tocopherol, delta-tocopherol to achieve bitterness reduction in lipids. Combination of peptides to reduce bitterness as in JP2009278917A may be used as strategy too. Also, a series of bitterness-masking auxiliary ingredient comprising a sugar alcohol, Agar, carrageenan, gellan gum, furcellaran, gelatin, curdlan, rhinoceros Rude seed gum, locust bean gum, xanthan gum, guar gum, pectin, alginic acid, alginates, at least from concentrations to 5-20% one gelling selected from the group consisting of mannan and tamarind gum are used by JP4647493B2.

However, preferred molecules to reduce bitterness are nucleotides and nucleosides (see below).

“Mushroom's nucleotides encompass the 5′-adenosine monophosphate (5′-AMP), 5′-cytosine monophosphate (5′-CMP), 5′-guanosine monophosphate (5′-GMP), 5′-inosine monophosphate (5′-IMP), 5′-uridine monophosphate (5′-UMP), and 5′-xanthosine monophosphate (5′-XMP)” (Chia-Wei Phan, 2017). Here the reported bitter blocker effects of nucleotides which fundamental to cover the bad taste of most amino acids “Blocking taste receptor activation of gustducin inhibits gustatory responses to bitter compounds” (Ding Ming, 1999) See https://www.ncbi.nlm.nih.gov/pmc/articles/PMC22308/. The above is especially useful for the case for Valine, Leucine, Cysteine among others (most of the amino acids excepting glycine, glutamate, and alanine taste bad). Moreover, natural bitter blockers as TrueClear or mushroom concentrate are cheaper than AMP, GMP or any nucleotide buy. A meal mimic is a unique product which may contain up to 15 grams of amino acids in free form and up to 13 grams of amino acids in peptide form. The combination with a bitter blocker may be useful

### EXAMPLE 10

A Method of Making a Meal Mimic

Emulsification step or gelation with wax step. Coconut oil and avocado oil could be integrated to an emulsion in a proportion in relation four parts of oil vs. one part of water; in other words, one meal mimic may have 23 grams of oil vs. 10 grams of water, or 23 grams of oil vs. 8 grams of water. Another way is to work without emulsion, in that case beeswax and other vegetable waxes, for example one or more of sunflower wax, carnauba wax, candelilla wax, berry wax, and fruit wax, may be used in ranges from 2-10% w/w respecting to the oil. Especially good results are obtained with 5% beeswax. Oils mixture w/o wax is mixed with USDA approved essential oils for flavor and smell as orange oil, lime oil among others; if the emulsion is preferred water has to be added. First emulsified without an emulsifier during 5 minutes at 2000-3500 RPM after that fiber from a vegetable source is added and the emulsification procedure continues together with vitamins and minerals.

One or more of tapioca starch, high methoxy pectin, and collagen peptides may be added, and may help to stabilized the fat blend.

The paste obtained may be mixed. The mixing may be for 5 to 10 minutes. The mixing temperature may be room temperature, 60° C., or a temperature in a range therebetween.

Regardless of whether the selected step was emulsion or wax addition, the following step may be the addition of: free amino acids with vitamins; sweeteners or powder artificial flavors. The mix may also include one or more of starches, citric acid, and collagen peptides. This mix is integrated to the gelatin mixture.

For instance, fiber from mushrooms dried concentrate (please see the steps to obtain the dried mushroom concentrate), at this step from 30 mg to 200 mg of fiber source can be used. Other fibers or gums as Arabic gum, xanthan gum, and guar gums can be used. During the blending or mixing process, small amounts of benzoic acid are added from 5 to 15 mg for mold and bacteria control.

A step of gelatinization or solidification is performed at this point with flavor or flavorless gelatin, which may be mixed with the amino acid and peptide mixture; the gelatin is hydrated approximately one to one ratio with hot water (60 to 80° C.). The gelatins are selected according to the bloom scale in a range from 200 to 300 bloom, the gelatin is added to the mixture and agitated vigorously to open the collagen and integrate the oil inside of the meal mimic.

The essential oils can be integrated into the emulsion or the wax oleogel step, or they can be added almost during the solidification process. Vegetable color and the extra flavor is added, essential oils from fruits like orange, lime, or mango, but the extra flavors are not limited to these flavors.

The liquid mixture is cast on molds with a cube shape of 1 to 1.5-inch side. The cube is preferred, but other forms can be used for this matter as stars, circular, spheres, parallelepiped among other styles.

Solidification is performed at 0° C. for 45 minutes. However, this can also be conducted at 4 to 10° C. for 2 to 4 hours.

The cubes are cast out from the molds and meal in a pill is ready to eat. The cubes can contain from 200 Cal to 500 Cal depending the selected composition. Please see the examples.

The aim of the gums/fibers and the wax is to provide a solid matrix which makes the meal in a pill stable up to 110° F. Also, if the temperature is increased up to 140° F. meal mimic will melt and retain the form of the container; however, as soon as the meal in a pill returns to ideal room temperatures from 70 to 80° F. and below it will solidify again retaining its taste and nutritional properties.

### EXAMPLE 11

The inventors tested the meal in a pill in three young men subjects with ages between 23-32 years. The meal in a pill formula can provide sufficient dietary substance for periods from 4 up to 8 hours. It is hypothesized that the amino acids are slowly released by the gelatine/gum/fat composite providing satiety possible during 15 days without weight loss and with a high level of activity. Current experiments are also being conducted in pigs.

It is also hypothesized that the unique combination of biopolymers, gums, and macronutrient composition is controlling calorie consumption by providing the right amino acids, and emulating real protein, lipids, carbohydrates, and micronutrients. An innovation underling a meal mimic is a nutritional balance mimicking real foods with amino acid profiles for protein, carbohydrates, lipids, and micronutrients.

### EXAMPLE 12

The following table compares nutritional facts for avocado, salmon, kale, and sweet potato versus a meal mimic (Meepo) that mimics an avocado, salmon, kale, and sweet potato meal.

| | | | | | | Meepo (Avocado, | |
|---|---|---|---|---|---|---|---|
| | | | | | | Salmon, Kale, | |
| | Avocado | Salmon | Kale | Sweet potato | vs | Sweet potato) | |
| Total Weight | 50 | 100 | 50 | 100 | g | 70 | g |
| Total Fat | 8 | 10.5 | 0 | 0 | g | 20 | g |
| Saturated Fat | 1 | 3.5 | 0 | 0 | g | 10 | g |
| Mono Unsaturated | 5 | 3 | 0 | 0 | g | 7 | g |
| Fat | | | | | | | |
| Poly unsaturated | 1 | 4 | 0 | 0 | g | 3 | g |
| Fat | | | | | | | |
| Protein | 1 | 20 | 0 | 1 | g | 22 | g |
| Carbohydrates | 2 | | 2 | 15 | | 20 | g |
| Water | 35 | 69.5 | 90 | 80 | | 8 | g |
| Vitamin D | 0 | 100 | | | % | 120 | % |
| Calcium | 0 | 0 | 9.4 | | % | 30 | % |
| Iron | 2 | 2 | | | % | 30 | % |
| Potassium | 6 | 0 | 6.5 | 13.5 | % | 45 | % |
| Vitamin A | 0 | 2 | 354 | 300 | % | 50 | % |
| Vitamin C | 4 | | 88 | 30 | % | 80 | % |
| Vitamin E | 6 | 0 | 0 | 0 | % | 40 | % |
| Vitamin K | 10 | | 1327 | 0 | % | 120 | % |
| Thiamin | 4 | 0 | 4.6 | 0 | % | 40 | % |
| Riboflavin | 0.1 | 0 | 0 | 0 | % | 56 | % |
| Niacin | 6 | 0 | 0 | 7 | % | 70 | % |
| Vitamin B6 | 6 | 0 | 9 | 15 | % | 60 | % |
| Folate | 10 | 0 | 0 | 0 | % | 25 | % |
| Vitamin B12 | 0 | 40 | 0 | 0 | % | 130 | % |
| Biotin | 0 | 0 | 0 | 0 | % | 100 | % |
| Pantothenic | 15 | 0 | 0 | 9 | % | 50 | % |
| Acid | | | | | | | |
| Phosphorus | 2 | 0 | 0 | 0 | % | 40 | % |
| Iodine | 0 | 0 | 0 | 0 | % | 70 | % |
| Magnesium | 4 | 0 | 5.8 | 0 | % | 45 | % |
| Zinc | 2 | 0 | 0 | 0 | % | 40 | % |
| Selenium | 0 | 40 | 0 | 0 | % | 120 | % |
| Copper | 10 | 0 | 0 | 8 | % | 45 | % |
| Manganese | 4 | 0 | 0 | 0 | % | 45 | % |
| Chromium | 0 | 0 | 0 | 0 | % | 110 | % |
| Molybdenum | 0 | 0 | 0 | 0 | % | 110 | % |
| Chloride | 0 | 0 | 0 | 0 | % | 45 | % |
| % Daily Value | | | | | | | |
| (DV) | | | | | | | |

Any range herein may be divided into subranges. The low endpoint of a subrange may be selected from the lowest value of the range and every single increment value of the lowest decimal position in the range up to a single increment value of the lowest decimal position less than the high point of the range. The high endpoint of a subrange may be selected from one increment of the lowest decimal position above the lowest value in the range and every single increment value of the lowest decimal position in the range up to highest value in the range.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner(s) in which the teachings of the reference are incorporated. However, a citation of a reference at a particular location does not limit the manner in which all of the teachings of the cited reference are incorporated for all purposes.

It is understood, therefore, that the invention is not limited to the particular embodiments disclosed, but is intended to cover all modifications which are within the spirit and scope of the invention as defined by the appended claims and the above description.

What is claimed is:

1. A meal mimic in the form of a solid mass comprising at least one source of peptides or amino acids, a ratio of calories to weight of 4.8 Cal/g or higher, and a volume equivalent to a cube of 0.8 to 1.3 inch per side.

2. The meal mimic of claim 1, wherein the source of peptides or amino acids comprises at least one of hydrolyzed collagen, rice, wheat, free amino acids and peptides.

3. The meal mimic of claim 1 further comprising on or more of starch, lipids, oligosaccharides, and carbohydrates.

4. The meal mimic of claim 1, wherein the at least one source of peptides or amino acids has an amino acid content mimicking an amino acid content of a target protein.

5. The meal mimic of claim 1 further comprising a bitter blocker composition.

6. The meal mimic of claim 5, wherein the bitter blocker composition comprises one or more of natural bitter blockers, arabic gum, dry mushrooms, plant based bitter blockers, TrueBlock®,TrueClear®, TruBlock™ Core, TruBlock™ Ultra Powder MSDS, and a combination of 78-95% acacia gum, 1-6% flavor extracts, and 2-15% acerola cherry extract.

7. A meal mimic in the form of a solid mass comprising at least one source of peptides or amino acids, wherein the at least one source of peptides or amino acids has one or more of an amino acid content or profile mimicking one or more of an amino acid content or profile of a target protein, and the meal mimic has a volume equivalent to a cube of 0.8 to 1.3 inch per side.

8. The meal mimic of claim 7, wherein the target protein is one or more selected from the group consisting of fish, pork, goat, chicken, egg, beef, pea, salmon, insect, plant, milk, whey protein isolate, hydrolyzed whey protein, milk protein isolate, soy protein isolate, and pea protein isolate protein.

9. The meal mimic of claim 7 comprising hydrolysates from animal sources selected from the group consisting of cow, goat, salmon, fish, chicken, whey protein isolate, hydrolyzed whey protein, milk protein isolate, soy protein isolate, and pea protein isolate.

10. The meal mimic of claim 7 comprising a bitter blocker composition comprising one or more of natural bitter blockers, arabic gum, dry mushrooms, plant based bitter blockers, TrueBlock®,TrueClear®, TruBlock™ Core, TruBlock™ Ultra Powder MSDS, and a combination of 78-95% acacia gum, 1-6% flavor extracts, and 2-15% acerola cherry extract.

11. The meal mimic of claim 7 further comprising one or more of starch, lipids, oligosaccharides, and carbohydrates.

12. The meal mimic of claim 11, wherein the carbohydrates mimic those found in a meal including at least one of sweet potato, kale, or avocado, or in a meal including at least one of steak and sweet potato.

13. The meal mimic of claim 7, wherein the meal mimic has a glycemic index mimicking a meal comprising at least one of sweet potato, kale, or avocado or a meal comprising at least one of steak and sweet potato.

14. The meal mimic of claim 7, wherein the peptides or amino acids are stable for at least about 36 months when vacuum sealed packed or nitrogen purged with storage at 20° C.

15. A method of making the meal mimic comprising:
emulsifying oils and water without an emulsifier,
adding at least one of fiber from a vegetable source, vitamins, and minerals while continuing emulsifying,
blending in starches, peptides and/or amino acids, citric acid, benzoic acid,
adding sweetener,
adding liquid gelatin of 200 to 300 bloom,
agitating vigorously,
adding vegetable color and extra flavor,
casting the liquid mixture obtained in molds,
solidifying, and
uncasting the meal mimic from the molds.

16. The method of claim 15, wherein the blending in step is performed at 60° C.

17. The method of claim 15 further comprising adding stabilizers.

18. The method of claim 15 further comprising adding at least one of cellulose, methyl-cellulose, ethyl-cellulose, oleo-gel, or beeswax, preferably after the adding sweetener step.

19. The method of claim 15, wherein the extra flavor is selected from essential oils from one or more fruit.

20. The method of claim 19, wherein the one or more fruit are selected from orange, lime, and mango.

21. The method of claim 15, wherein the solidifying comprises gelation at 0° C. for 45 minutes.

22. A meal mimic prepared by the method of claim 15.

23. The meal mimic of claim 22, wherein the meal mimic mimics a salmon meal or a steak meal.
